(19) United States
(12) Patent Application Publication
(10) Pub. No.: US 2007/0200019 A1
(43) Pub. Date: Aug. 30, 2007

(54) Chucking plate, tape reel, cartridge case, and information recording medium

(75) Inventor: Hiroki Suzuki, Tokyo (JP)

Correspondence Address: GREENBLUM & BERNSTEIN, P.L.C., 1950 ROLAND CLARKE PLACE, RESTON, VA, 20191, US

(73) Assignee: TDK Corporation, Tokyo (JP)

(21) Appl. No.: 11/362,188

(22) Filed: Feb. 27, 2006

(51) Int. Cl. G11B 23/107

(52) U.S. Cl. 242/348

(57) ABSTRACT

A chucking plate includes a disk-shaped main portion formed of a magnetic material and at least one hook portion erected on the main portion. The chucking plate is capable of being attached to a bottomed cylinder-shaped hub of a tape reel by inserting the at least one hook portion into one of at least one hole and at least one concave part formed in a base plate of the hub.

### BACKGROUND OF THE INVENTION

1. Field of the Invention

The present invention relates to a chucking plate that is attached to a hub of a tape reel, a tape reel equipped with such chucking plate, a cartridge case equipped with such tape reel, and an information recording medium equipped with such cartridge case.

2. Description of the Related Art

As one example of an information recording medium capable of recording a large amount of data, a magnetic tape cartridge disclosed by Japanese Laid-Open Utility Model Publication No. H04-45359 is known. This magnetic tape cartridge includes a reel that has a pair of flanges attached to both ends of a hub, and a reel plate (hereinafter simply “chucking plate”) for chucking the reel to a drive shaft of a drive apparatus by magnetic attraction is integrally embedded in the hub of the reel. In this magnetic tape cartridge, by attaching the chucking plate to the hub by insert molding, it is possible to reliably fix the chucking plate to the hub.

By investigating the magnetic tape cartridge described above, the present inventor discovered the following problem. That is, in this magnetic tape cartridge, by attaching the chucking plate to the hub by insert molding, the chucking plate is reliably fixed to the hub. On the other hand, due to the increased interest for environmental protection and reduced resource use in recent years, defective products produced during the manufacturing process for magnetic tape cartridges and magnetic tape cartridges whose storage life has expired and therefore need to be disposed of are being increasingly reused. In this case, to efficiently reuse the magnetic tape cartridges, it is necessary to collect the components constructing each magnetic tape cartridge having sorted the components into the respective raw materials. However, with the magnetic tape cartridge described above, since the hub and the chucking plate that are formed of respectively different raw materials such as resin and metal are firmly fixed together by insert molding, it is not realistically possible to completely separate the hub and the chucking plate even if the hub is destroyed. Solving this problem would therefore be preferable in terms of improving the efficiency of collection by type, and in turn the efficiency of the reuse of resources.

### SUMMARY OF THE INVENTION

The present invention was conceived in view of the problem described above and it is a principal object of the present invention to provide a chucking plate, a tape reel, a cartridge case, and an information recording medium that can improve the efficiency of the reuse of resources.

To achieve the stated object, a chucking plate according to the present invention includes a disk-shaped main portion formed of a magnetic material and at least one hook portion erected on the main portion, wherein the chucking plate is capable of being attached to a bottomed cylinder-shaped hub of a tape reel by inserting the at least one hook portion into one of at least one hole and at least one concave part formed in a base plate of the hub.

In the same way, a tape reel according to the present invention includes a bottomed cylinder-shaped hub and a chucking plate attached to the hub, wherein one of at least one hole and at least one concave part is formed in a base plate of the hub, and the chucking plate includes a disk-shaped main portion formed of a magnetic material and at least one hook portion erected on the main portion, wherein the chucking plate is attached to the hub by inserting the at least one hook portion into the one of at least one hole and at least one concave part.

A cartridge case according to the present invention has a tape reel, which includes a bottomed cylinder-shaped hub and a chucking plate attached to the hub, and a case body that rotatably houses the tape reel, wherein one of at least one hole and at least one concave part is formed in a base plate of the hub, and the chucking plate includes a disk-shaped main portion formed of a magnetic material and at least one hook portion erected on the main portion, wherein the chucking plate is attached to the hub by inserting the at least one hook portion into the one of at least one hole and at least one concave part.

An information recording medium according to the present invention includes: a cartridge case having a tape reel, which includes a bottomed cylinder-shaped hub and a chucking plate attached to the hub, and a case body that rotatably houses the tape reel; and a magnetic tape wound around the tape reel, wherein one of at least one hole and at least one concave part is formed in a base plate of the hub, and the chucking plate includes a disk-shaped main portion formed of a magnetic material and at least one hook portion erected on the main portion, wherein the chucking plate is attached to the hub by inserting the at least one hook portion into the one of at least one hole and at least one concave part.

According to the chucking plate, the tape reel, the cartridge case, and the information recording medium described above, the chucking plate is constructed so as to be capable of being attached to the hub of a tape reel by inserting the at least one hook portion into the one of at least one hole and at least one concave part formed in the base plate of the hub. This means that unlike a conventional construction where the chucking plate and the hub are strongly fixed together by attaching the chucking plate to the hub by insert molding, and unlike a conventional construction where the chucking plate and the hub are fixed together by melting convex parts inserted into holes in the chucking plate, a chucking plate and a hub made of different raw materials can be separated more reliably and easily since a process that breaks the melted parts of the convex parts is no longer necessary. For this reason, it is possible to improve the efficiency of collection by type, and in turn the efficiency of the reuse of resources.

Here, a chucking plate where three of the at least one hook portion are erected at equal intervals on an outer circumferential edge of the main portion may be used. With this construction, even if a force oriented so as to pull out the chucking plate is applied to the chucking plate, such force can be distributed equally among the three hook portions and therefore it is possible to reliably fix the chucking plate to the hub.

Also, a chucking plate may be used where a bent-back portion capable of elastic deformation is formed at a front end of each hook portion. With this construction, when the at least one hook portion is inserted into the at least one hole or the at least one concave part, the bent-back portion is pressed toward the base portion of the at least one hook portion and elastically deform, and therefore the at least one hook portion can be easily inserted into the at least one hole or the at least one concave part. Also, if a hole is formed in the base plate of the hub, for example, when the bent-back portion is caused to protrude toward the inner surface of the base plate from the hole, the bent-back portion springs back to its pre-insertion shape so that the front end of the bent-back portion is positioned outside the hole, and therefore even if a force oriented so as to pull out the chucking plate is applied to the chucking plate, the front end of the bent-back portion contact the edges of the hole in the base plate to prevent movement of the chucking plate. As a result, the chucking plate can be reliably prevented from dropping off.

In addition, a chucking plate where the at least one hook portion is formed by bending the magnetic material and is constructed integrally with the main portion may be used. With this construction, compared, for example, to a construction where separately constructed hook portions are fixed to the main portion by welding or the like, the chucking plate can be fabricated easily.

### BRIEF DESCRIPTION OF THE DRAWINGS

These and other objects and features of the present invention will be explained in more detail below with reference to the attached drawings, wherein:

FIG. 1 is an exploded perspective view of an information recording medium;

FIG. 2 is a cross-sectional view of an information recording medium;

FIG. 3 is a plan view of a tape reel when looking from a lower flange side thereof;

FIG. 4 is a plan view of a chucking plate;

FIG. 5 is a perspective view of the tape reel and the chucking plate;

FIG. 6 is a cross-sectional view of the chucking plate and the hub before attachment;

FIG. 7 is a cross-sectional view of the chucking plate and the hub in a state where hook portions of the chucking plate have been inserted into insertion holes of the hub;

FIG. 8 is a cross-sectional view of the chucking plate and the hub in a state where attachment of the chucking plate on the hub is completed; and

FIG. 9 is a cross-sectional view of the chucking plate and the hub in a state where bent-back portions are squeezed by pliers.

### DESCRIPTION OF THE PREFERRED EMBODIMENTS

Preferred embodiments of a chucking plate, a tape reel, a cartridge case, and an information recording medium according to the present invention will now be described with reference to the attached drawings.

First, the construction of an information recording medium 1 will be described with reference to the drawings.

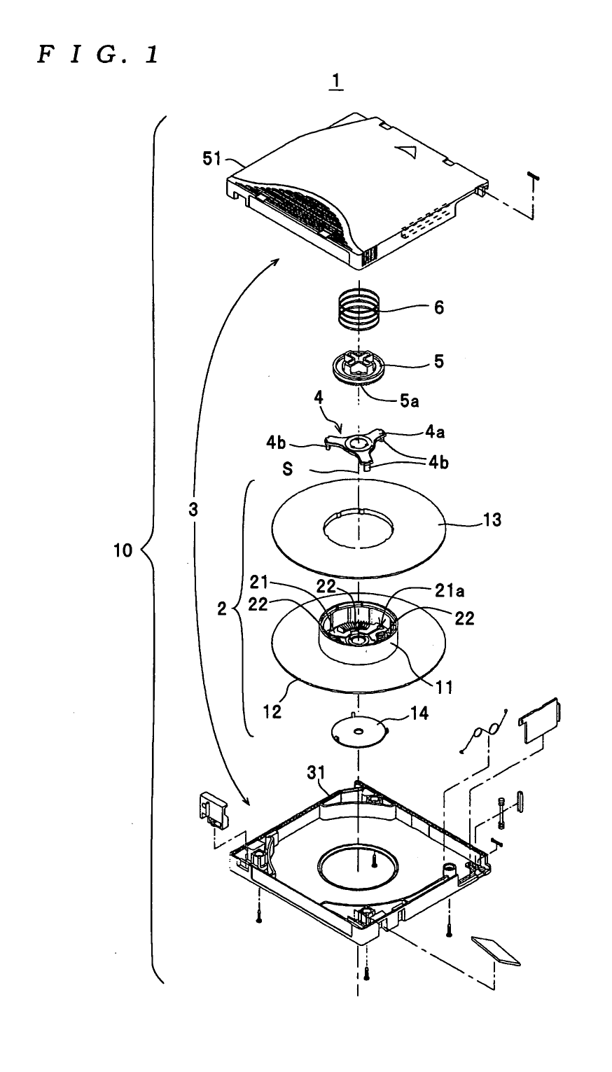

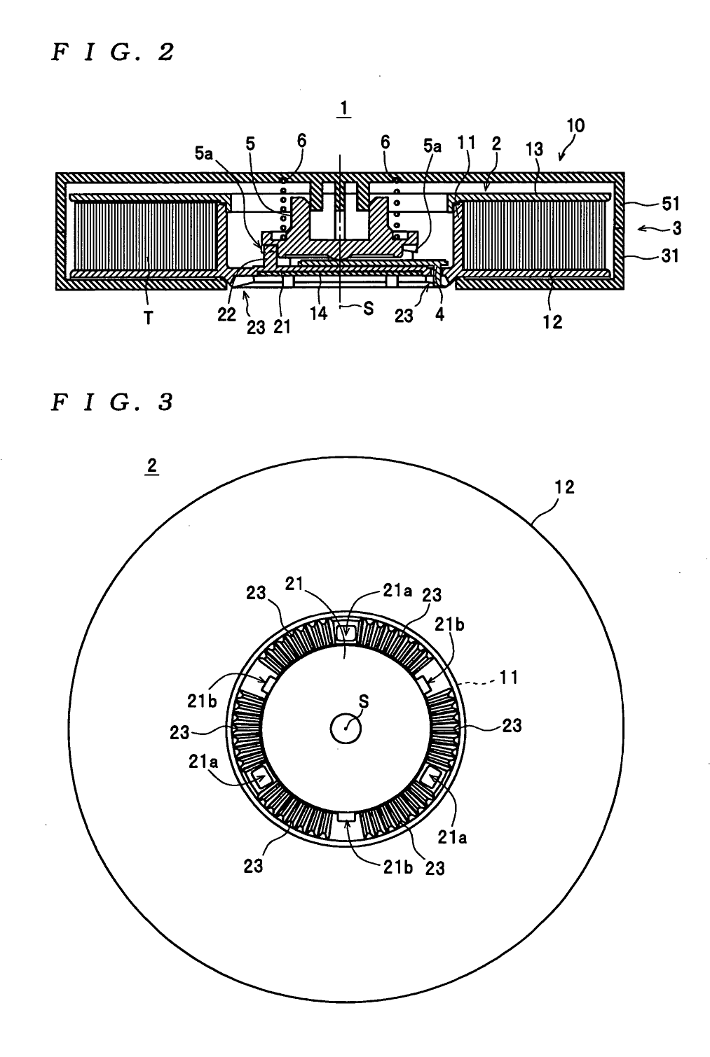

The information recording medium 1 shown in FIGS. 1 and 2 is a single-reel type information recording medium used as a storage device for backing up data recorded by an electronic computer, for example, and as shown in the drawings includes a cartridge case 10 having: a tape reel 2, a case body 3, a brake releasing plate 4, a locking member 5, and a brake spring 6; and a magnetic tape T (see FIG. 2) wound around the tape reel 2. It should be noted that for ease of understanding the constructions of the various components, the magnetic tape T is omitted in FIG. 1.

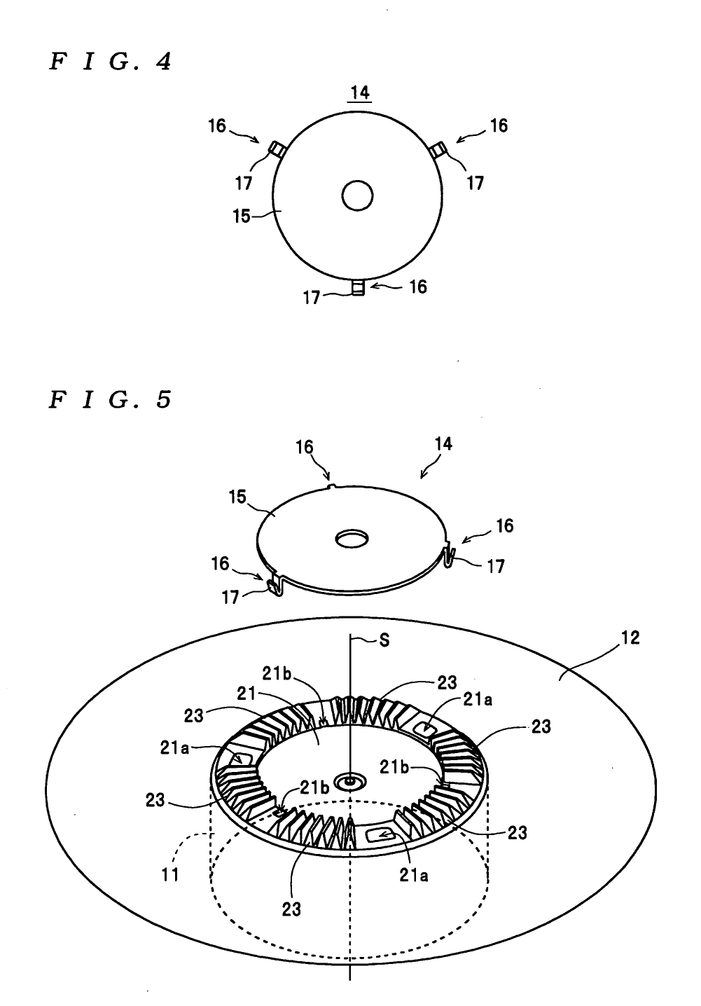

As shown in FIG. 1, the tape reel 2 includes a hub 11, a lower flange 12, an upper flange 13, and a chucking plate 14. The hub 11 is formed as a bottomed cylinder where an opening is formed at an upper end thereof, and is constructed so that the magnetic tape T can be wound therearound. As shown in FIGS. 1 and 2, three sets of brake teeth 22 that are arc-shaped when viewed from above and engage teeth 5a of the locking member 5 energized by the brake spring 6 are formed on the inner surface of the base plate 21 of the hub 11 so as to be positioned on a circle about an axis S of the hub 11. As shown in FIGS. 3 and 5, six sets of driven teeth 23 that are arc-shaped when viewed from above and engage driving teeth of a drive shaft of a drive apparatus (not shown) are formed on an outer surface of the base plate 21 so as to be positioned on a circle about the axis S. In addition, as shown in FIGS. 3 and 5, three through-holes 21a for attaching the brake releasing plate 4 (see FIG. 1) so as to be capable of up-down movement and three insertion holes 21b (one example of “holes” for the present invention) into which hook portions 16 (see FIG. 4) of the chucking plate 14 described later can be inserted are formed in the base plate 21 so as to be alternately located in the six intervals formed between adjacent sets of driven teeth 23. That is, the insertion holes 21b are formed in every other interval out of the six intervals.

As shown in FIGS. 3 and 5, the lower flange 12 is disk-shaped and is integrally formed at a lower end (the end located at the top in FIG. 5) of the hub 11. As shown in FIG. 1, the upper flange 13 is also disk-shaped, and is fixed to the open end of the hub 11.

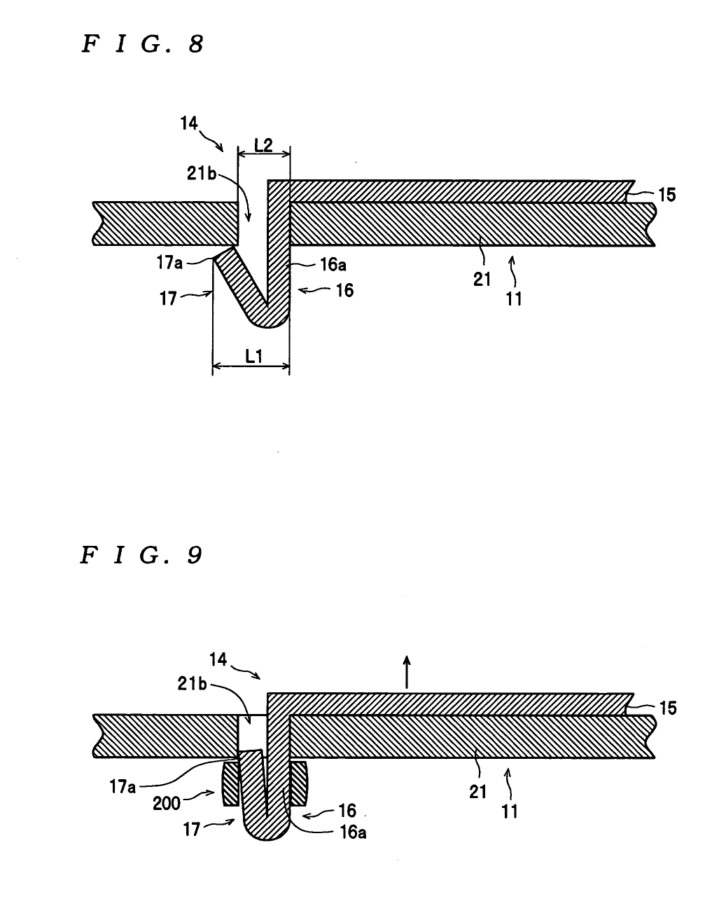

The chucking plate 14 is one example of a “chucking plate” for the present invention, and as shown in FIGS. 4 and 5, includes a main portion 15 and three hook portions 16 that are integrally formed by bending a magnetic material such as iron or stainless steel that exhibit elasticity. By inserting the hook portions 16 into the insertion holes 21b formed in the base plate 21 of the hub 11 as shown in FIG. 8, the chucking plate 14 is attached to the outer surface (the upper surface in FIG. 8) of the base plate 21. When the information recording medium 1 is set in a drive apparatus, the chucking plate 14 is pulled by magnetic attraction to a magnetic attraction portion of the drive shaft of the drive apparatus and therefore functions so that the driving teeth of the drive shaft engage the driven teeth 23 formed on the base plate 21, thereby chucking the drive shaft and the tape reel 2.

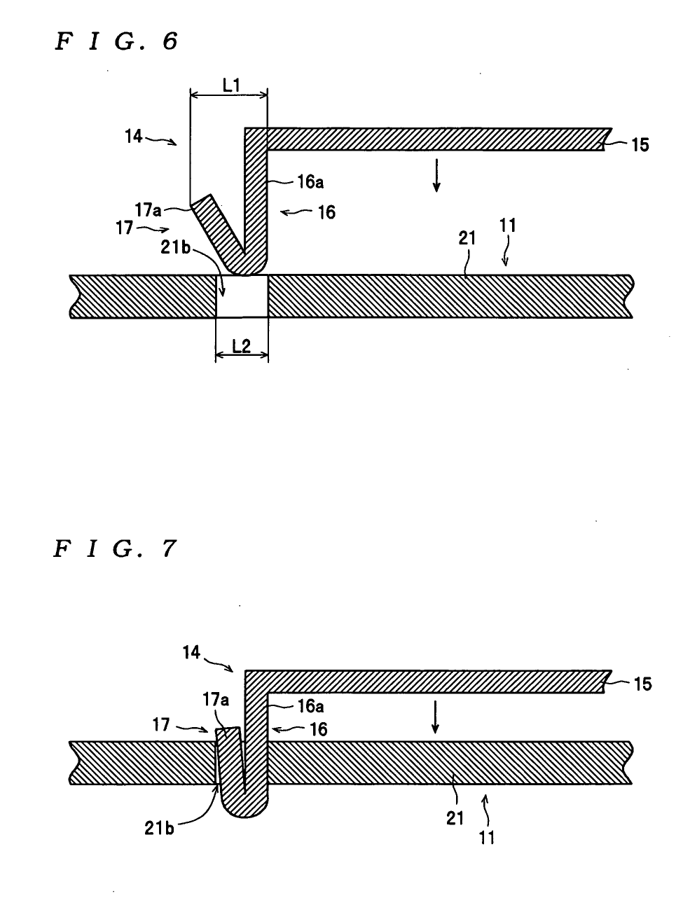

Here, the main portion 15 is formed in a disk shape with an outer diameter that is slightly smaller than the diameter of a virtual circle that joins the inner circumferences of the sets of driven teeth 23. The hook portions 16 are formed at positions an equal distance apart on the outer circumferential edge of the main portion 15. Also, as shown in FIGS. 4 to 9, bent-back portions 17 that are bent back toward the outside are formed at front ends of the hook portions 16. Here, since the chucking plate 14 is formed of a magnetic material that is elastic, the bent-back portions 17 are capable of elastic deformation. Also, as shown in FIG. 6, the bent-back portions 17 are formed so that the length L1 between base portions 16a and the front end portions 17a of the hook portions 16 in a non-pressed state is longer than the opening length L2 of the insertion holes 21b in the radial direction (the left-right direction in FIG. 6) of the base plate 21. This means that as shown in FIG. 7, when the hook portions 16 are inserted into the insertion holes 21b, the bent-back portions 17 elastically deform so as to approach the base portions 16a of the hook portions 16 and as shown in FIG. 8, when the bent-back portions 17 are caused to protrude toward the inner surface (the lower surface in FIG. 8) of the base plate 21 from the insertion holes 21b, the bent-back portions 17 spring back to their non-pressed state, thereby preventing detachment of the hook portions 16 from the insertion holes 21b or in other words preventing the chucking plate 14 from dropping off the base plate 21.

As shown in FIGS. 1 and 2, the case body 3 is constructed of a lower case 31 and an upper case 51 constructed so as to fit together and rotatably houses the tape reel 2 in an internal space formed when the lower and upper cases 31 and 51 are fitted together. As shown in FIG. 1, the brake releasing plate 4 includes a main body 4a and three legs 4b that can pass through the through-holes 21a of the hub 11, and by passing the respective legs 4b through the through-holes 21a, as shown in FIG. 2 the brake releasing plate 4 is disposed on the base plate 21 inside the hub 11 so as to be capable of up-down movement. As shown in FIG. 1, the teeth 5a that can engage the brake teeth 22 of the hub 11 are formed on the base surface of the locking member 5. The brake spring 6 is disposed between the upper case 51 and the locking member 5 and energizes the locking member 5 toward the base plate 21 of the hub 11 of the tape reel 2.

Next, the method of manufacturing the information recording medium 1 will be described with reference to the drawings, focusing on an assembly procedure for the tape reel 2.

First, the chucking plate 14 is attached to the outer surface of the base plate 21 of the tape reel 2. More specifically, as shown in FIG. 6, the hook portions 16 of the chucking plate 14 are inserted into the insertion holes 21b formed in the base plate 21. At this time, since the bent-back portions 17 are constructed so as to be capable of elastic deformation, as shown in FIG. 7, as the hook portions 16 are inserted, the bent-back portions 17 are pressed toward the base portions 16a of the hook portions 16 and deform elastically. Next, as shown in FIG. 8, when the bent-back portions 17 are caused to protrude toward the inner surface (the lower surface in FIG. 8) of the base plate 21 from the insertion holes 21b, the pressing force that accompanies the insertion is removed, resulting in the bent-back portions 17 springing back to their pre-insertion form. By doing so, the chucking plate 14 is fixed to the tape reel 2 (the hub 11), thereby completing the attachment of the chucking plate 14. Here, since the bent-back portions 17 are formed so that the length L1 between the base portions 16a and the front end portions 17a of the hook portions 16 in the non-pressed state is longer than the opening length L2 of the insertion holes 21b, as shown in FIG. 8, the front end portions 17a of the bent-back portions 17 in this state become positioned outside the insertion holes 21b (i.e., closer to the outer edge of the base plate 21 of the hub 11). Accordingly, even if a force is applied to the chucking plate 14 in a direction so as to detach the chucking plate 14 (upward in FIG. 8), the front end portions 17a of the bent-back portions 17 contact the edge of the insertion holes 21b of the base plate 21 and prevent the chucking plate 14 from moving. As a result, the chucking plate 14 is prevented from dropping off.

Next, by using a welding apparatus, the upper flange 13 is welded to the open end of the hub 11 that has been integrally formed with the lower flange 12. After this, using a testing apparatus, a defective/non-defective test is carried out to investigate whether skewing of the lower flange 12 and the upper flange 13 is within a predetermined amount. By doing so, the assembly of the tape reel 2 is completed.

Next, components such as the assembled tape reel 2, the brake releasing plate 4, the locking member 5, and the brake spring 6 are arranged on the lower case 31 and the upper case 51 and the lower case 31 and the upper case 51 are then screwed together. By doing so, the cartridge case 10 is completed. Next, the magnetic tape T is wound onto the tape reel 2 inside the cartridge case 10 (the case body 3) using a tape winding device. After this, various tests are carried out on the cartridge case 10 into which the magnetic tape T has been wound and products determined to be non-defective are completed as the information recording medium 1.

On the other hand, when disposing of tape reels 2 determined to be defective by tests or the like during the manufacturing process of the information recording medium 1 (the cartridge case 10) and of tape reels 2 of information recording media 1 whose storage period has expired and therefore need to be scrapped, the respective chucking plates 14 are removed from the hubs 11. More specifically, as shown in FIG. 9, by squeezing the bent-back portions 17 of the hook portions 16 of the chucking plate 14 using pliers 200, for example, the bent-back portions 17 are caused to elastically deform toward the base portions 16a of the hook portions 16. Next, in this state, the hook portions 16 are pulled out from the insertion holes 21b of the hub 11. By doing so, the removal of the chucking plate 14 from the hub 11 is completed. Here, although it is difficult to separate the chucking plate and the hub with a conventional construction where the chucking plate and the hub are strongly fixed together by attaching the chucking plate to the hub by insert molding, with the tape reel 2, by causing the bent-back portions 17 of the hook portions 16 to deform, the chucking plate 14 can be easily removed from the hub 11. For this reason, the chucking plate 14 and the hub 11 that are made of different raw materials can be reliably and easily separated. Accordingly, it is possible to improve the efficiency of collection by type, and in turn the efficiency of the reuse of resources.

In this way, according to the chucking plate 14, the tape reel 2, the cartridge case 10, and the information recording medium 1, by constructing the chucking plate 14 so as to be attachable to the hub 11 of the tape reel 2 by inserting the hook portions 16 into the insertion holes 21b formed in the base plate 21 of the hub 11, unlike the conventional construction where the chucking plate and the hub are strongly fixed together by attaching the chucking plate and the hub by insert molding, it is possible to reliably and easily separate the chucking plate 14 and the hub 11 that are made of different raw materials. For this reason, it is possible to reliably improve the efficiency of collection by type, and in turn the efficiency of the reuse of resources.

In addition, according to the chucking plate 14, the tape reel 2, the cartridge case 10, and the information recording medium 1, by erecting the three hook portions 16 at equal intervals on the outer circumferential edge of the main portion 15, even if a force oriented so as to pull out the chucking plate 14 is applied to the chucking plate 14, such force can be distributed equally among the three hook portions 16 and therefore it is possible to reliably fix the chucking plate 14 to the hub 11.

In addition, according to the chucking plate 14, the tape reel 2, the cartridge case 10, and the information recording medium 1, by forming the bent-back portions 17 that are capable of elastic deformation at the front ends of the hook portions 16, when the hook portions 16 are inserted into the insertion holes 21b, the bent-back portions 17 are pressed toward the base portions 16a of the hook portions 16 and elastically deform, and therefore the hook portions 16 can be easily inserted into the insertion holes 21b. Also, when the bent-back portions 17 are caused to protrude toward the inner surface (the lower surface in FIG. 8) of the base plate 21 from the insertion holes 21b, the bent-back portions 17 spring back to their pre-insertion shape so that the front end portions 17a of the bent-back portions 17 are positioned outside the insertion holes 21b, and therefore even if a force oriented so as to pull out the chucking plate 14 is applied to the chucking plate 14, the front end portions 17a of the bent-back portions 17 contact the edges of the insertion holes 21b of the base plate 21 to prevent movement of the chucking plate 14. As a result, the chucking plate 14 can be reliably prevented from dropping off.

In addition, according to the chucking plate 14, the tape reel 2, the cartridge case 10, and the information recording medium 1, by integrally forming the main portion 15 and the hook portions 16 by bending a magnetic material, compared, for example, to a construction where separately constructed hook portions 16 are fixed to the main portion 15 by welding or the like, the chucking plate 14 can be fabricated easily.

It should be noted that the present invention is not limited to the above construction. For example, although the chucking plate 14 that includes three hook portions 16 has been described as an example, the number of hook portions 16 is not limited to three and can be set at any arbitrary number. Also, although an example where the hook portions 16 are erected on the outer circumferential edge of the main portion 15 has been described above, the positions at which the hook portions 16 are erected are not limited to such and the hook portions 16 may be erected at any arbitrary positions on the main portion 15. It is also possible to use a construction where hook portions 16 constructed separately to the main portion 15 are fixed to the main portion 15. Also, although an example where the bent-back portions 17 are formed by bending the front ends of the hook portions 16 of the chucking plate 14 toward the outside has been described, it is possible to use a chucking plate 14 where the bent-back portions 17 are formed by bending the front ends of the hook portions 16 toward the inside. In addition, although an example where the hook portions 16 are inserted into the insertion holes 21b formed in the base plate 21 has been described, it is possible to use a construction where concave parts into which the hook portions 16 can be inserted are formed in the base plate 21 in place of the insertion holes 21b. Also, although a single-reel type information recording medium 1 has been described as an example, the information recording medium according to the present invention includes various kinds of information recording media that include a chucking plate.

What is claimed is:

1. A chucking plate comprising a disk-shaped main portion formed of a magnetic material and at least one hook portion erected on the main portion, wherein the chucking plate is capable of being attached to a bottomed cylinder-shaped hub of a tape reel by inserting the at least one hook portion into one of at least one hole and at least one concave part formed in a base plate of the hub.

2. A chucking plate according to claim 1, wherein three of the at least one hook portion are erected at equal intervals on an outer circumferential edge of the main portion.

3. A chucking plate according to claim 1, wherein a bent-back portion capable of elastic deformation is formed at a front end of each hook portion.

4. A chucking plate according to claim 1, wherein the at least one hook portion is formed by bending the magnetic material and is constructed integrally with the main portion.

5. A tape reel comprising a bottomed cylinder-shaped hub and a chucking plate attached to the hub,
wherein one of at least one hole and at least one concave part is formed in a base plate of the hub, and
the chucking plate includes a disk-shaped main portion formed of a magnetic material and at least one hook portion erected on the main portion, wherein the chucking plate is attached to the hub by inserting the at least one hook portion into the one of at least one hole and at least one concave part.

6. A cartridge case comprising a tape reel, which includes a bottomed cylinder-shaped hub and a chucking plate attached to the hub, and a case body that rotatably houses the tape reel,
wherein one of at least one hole and at least one concave part is formed in a base plate of the hub, and
the chucking plate includes a disk-shaped main portion formed of a magnetic material and at least one hook portion erected on the main portion, wherein the chucking plate is attached to the hub by inserting the at least one hook portion into the one of at least one hole and at least one concave part.

7. An information recording medium comprising: a cartridge case having a tape reel, which includes a bottomed cylinder-shaped hub and a chucking plate attached to the hub, and a case body that rotatably houses the tape reel; and a magnetic tape wound around the tape reel,
wherein one of at least one hole and at least one concave part is formed in a base plate of the hub,
and the chucking plate includes a disk-shaped main portion formed of a magnetic material and at least one hook portion erected on the main portion, wherein the chucking plate is attached to the hub by inserting the at least one hook portion into the one of at least one hole and at least one concave part.
